(19) United States
(12) Patent Application Publication
(10) Pub. No.: US 2018/0280891 A1
(43) Pub. Date: Oct. 4, 2018

(54) FILTRATION MEMBRANE WITH HIGH CHEMICAL RESISTANCE

(71) Applicant: LIKUID NANOTEK, S.L., San Sebastian (ES)

(72) Inventors: Jaione OLLO LOINAZ, San Sebastian (ES); Benjamin GOIKOETXEA GALDEANO, San Sebastian (ES); Francisco Javier LOPETEGUI GARNICA, San Sebastian (ES)

(21) Appl. No.: 15/940,093

(22) Filed: Mar. 29, 2018

(30) Foreign Application Priority Data
Mar. 30, 2017 (ES) P 201700329

(51) Int. Cl. B01D 69/10; B01D 69/04; B01D 69/02; C04B 35/462; C04B 38/00

(52) U.S. Cl. CPC B01D 69/105; B01D 69/04; B01D 69/02; C04B 35/462; C04B 2235/3232; B01D 2325/02; B01D 2325/24; B01D 2325/30; C04B 38/0054

(57) ABSTRACT

The present invention relates to a filtration membrane with high chemical resistance comprising a porous support with a primary titanium oxide powder and a secondary titanium oxide powder, wherein the primary powder has a grain size between 10 and 50 microns, and the secondary powder has a grain size at least 2 times smaller than the grain size of the primary powder, the grain size of the secondary powder being larger than 5 microns, and wherein the primary powder represents at least 50% by weight with respect to the total weight of the porous support, such that the porous support has a pore size between 1 and 7 microns and a percentage of porosity greater than 30%.

### CROSS REFERENCE TO RELATED APPLICATION

This application claims the benefit of priority from Spanish Patent Application No. P 201700329 filed Mar. 30, 2017, which is incorporated herein by reference.

### FIELD OF THE ART

The present invention relates to filtration elements used for separating different components contained in a liquid. The invention proposes a filtration membrane with a porous support made of a single ceramic material, i.e., titanium oxide, which has a high purity and narrow pore size distribution, giving rise to suitable filtration characteristics, mechanical strength characteristics, and a high resistance against chemical products during operation and different cleaning processes.

### STATE OF THE ART

Filtration membranes comprise a porous ceramic support on which thin ceramic layers are deposited. The porous support provides the mechanical rigidity required for membrane operation and is responsible for supporting the ceramic layers, whereas the ceramic layers work as a semi-permeable physical barrier separating the substances contained in the liquid to be filtered according to their size.

To make the porous supports, a ceramic paste with ceramic particles of aluminum oxide (Al₂O₃), titanium oxide (TiO₂), silicon oxide (SiO₂), silicon carbide (SiC), or a combination thereof is prepared, and the paste is extruded using different nozzles to obtain “green” porous supports. After extrusion, the “green” porous supports are subjected to a drying process and then to a thermal treatment of sintering in a high-temperature furnace until obtaining the degree of densification required for achieving the required porosity, strength/resistance, and permeability characteristics.

On one hand, the support must have a suitable mean pore size, a narrow pore size distribution, and a high porosity to enable supporting the layers that will be deposited thereon. On the other hand, the support must have high mechanical strength and high chemical resistance to prevent ruptures and withstand extreme pHs and chemical washes under aggressive alkaline and acid conditions, which may be increased with the temperature of the solution.

One of the ceramic materials that is most widely used for making porous supports is aluminum oxide (Al₂O₃) with which supports with high mechanical strength are obtained. However, the melting temperature of aluminum oxide particles is very high, where high sintering temperatures (>1700° C.) are required for obtaining a suitable porosity for the application of microfiltration layers.

Porous supports using a mixture of ceramic materials, such as aluminum oxide particles mixed with titanium oxide, among other ceramic materials, are also known. These supports allow using lower sintering temperatures since titanium oxide particles have a melting point in the order of 200° C. lower than aluminum oxide particles; however, the binding of different ceramic materials creates weak points leading to a decrease in the mechanical strength of the support, wherein said points are more sensitive to etchings.

Porous supports made only with titanium oxide are also known. These supports have the advantage of requiring a lower melting temperature than supports using aluminum oxide, and they furthermore prevent weak points from being generated since a single ceramic material is used. These supports are generally made with primary particles having a coarse grain size which are mixed with fine particles having a size in the order of 1 micron, which is considerably smaller than the size of the primary particles. Fine particles have higher reactivity than coarse particles such that they act as an inorganic binder of coarse particles during sintering. Despite the advantages mentioned above, using particles with grain sizes so different from one another makes it difficult to control the porosity of the support obtained, and therefore does not allow obtaining a porous support with a narrow pore size distribution, which is an essential requirement of filtration membranes since the highest possible porosity is required, maintaining suitable mechanical strength of the support.

Therefore, there is a need for a filtration membrane with a titanium oxide support suitable for the application of filtration layers, with a mean pore size particularly suitable for microfiltration, ultrafiltration, and nanofiltration applications, a narrow pore size distribution, and a high porosity, as well as the highest possible mechanical strength and resistance against chemical products.

### OBJECT OF THE INVENTION

The invention relates to a filtration membrane with a porous support made with a preferred grain size selection that allows obtaining a suitable porosity, a high mechanical strength, and a high filtration capacity for tangential (crossflow) filtration applications, particularly microfiltration, ultrafiltration, and nanofiltration applications. A single ceramic material, i.e., titanium oxide, which allows reducing the sintering temperature of the support to below 1500° C. is used to make the support, and since titanium oxide is a more chemically inert material, it allows improving resistance of the support against etchings.

The filtration membrane of the invention comprises a porous support with a primary titanium oxide powder and a secondary titanium oxide powder, wherein the primary powder has a grain size between 10 and 50 microns, and the secondary powder has a grain size at least 2 times smaller than the grain size of the primary powder, the grain size of the secondary powder being larger than 5 microns, and wherein the primary powder represents at least 50% by weight with respect to the total weight of the porous support.

Additionally, the filtration membrane comprises one or more porous layers of ceramic material deposited on the porous support having a pore size between 1 and 1000 nm. The ceramic material of the porous layers is selected from the group consisting of Al₂O₃, TiO₂, ZrO₂, or SiO₂.

A porous support having advantageous properties for tangential filtration applications is thereby obtained:
pore size between 1 and 7 microns,
percentage of porosity greater than 30%,
three-point mechanical bending strength greater than or equal to 40 MPa,
mechanical bending strength greater than 35 MPa measured after etching with HNO₃ with a concentration of 4% by weight at 70° C., or etching with NaOH with a concentration of 1.5% at 90° C.,
deionized water permeability greater than or equal to 5000 l/hm2 bar.

The addition of the secondary powder with a grain size at least 2 times smaller than the grain size of the primary powder, but always larger than 5 microns, allows controlling the pore size of the support, maintaining a narrow pore size distribution, such that a porous support is obtained with a pore size between 1 and 7 microns, and a percentage of porosity greater than 30%, but without compromising the mechanical strength of the support, where three-point bending strength (MOR) values greater than or equal to 40 MPa are obtained.

On the other hand, using titanium oxide powder of different grain size allows a larger contact area between the granules, since the granules of the secondary powder act as a linkage for the granules of the primary powder. The higher thermal reactivity of the secondary powder together with the foregoing favors densification of the granules at lower sintering temperatures, below 1500° C., and maintaining good mechanical properties of the support. A suitable grain size selection of the titanium oxide powder with which the support is made is thereby essential in order to attain suitable porosity and strength/resistance characteristics.

It must be taken into account that the pore size that is obtained increases with excessively low percentages of secondary powder that are too low, generating pores that are too large, and in contrast, with the addition of amounts of secondary powder that are too large, the pore size is too small to obtain a suitable permeability in filtration processes. The primary powder must therefore represent at least 50% by weight with respect to the total weight of the porous support, and preferably at least 70% by weight, such that a suitable pore size for microfiltration, ultrafiltration, and nanofiltration processes (a pore size of 1-7 microns) is assured.

A filtration membrane is thus obtained which, as a result of its structural characteristics and chemical composition, has high mechanical strength and chemical stability, since only titanium oxide is used in its composition when making the support, increasing its homogeneity and preventing “impurities” that result in weak points from a mechanical and chemical viewpoint. Furthermore, the membranes have a high permeability due to the high percentage of porosity of the support and a narrow pore size distribution, and due to the suitable combination of powder having a different grain size.

### DESCRIPTION OF THE DRAWINGS

FIG. 1 shows a perspective view of a filtration membrane with a tubular morphology.

FIG. 2 shows a longitudinal section view of the membrane of the preceding drawing.

FIG. 3 is a graph showing the pore size distribution of the porous support of the filtration membrane of the invention.

FIG. 4 is a graph showing the deionized water permeability of the porous support of the filtration membrane of the invention.

### DETAILED DESCRIPTION OF THE INVENTION

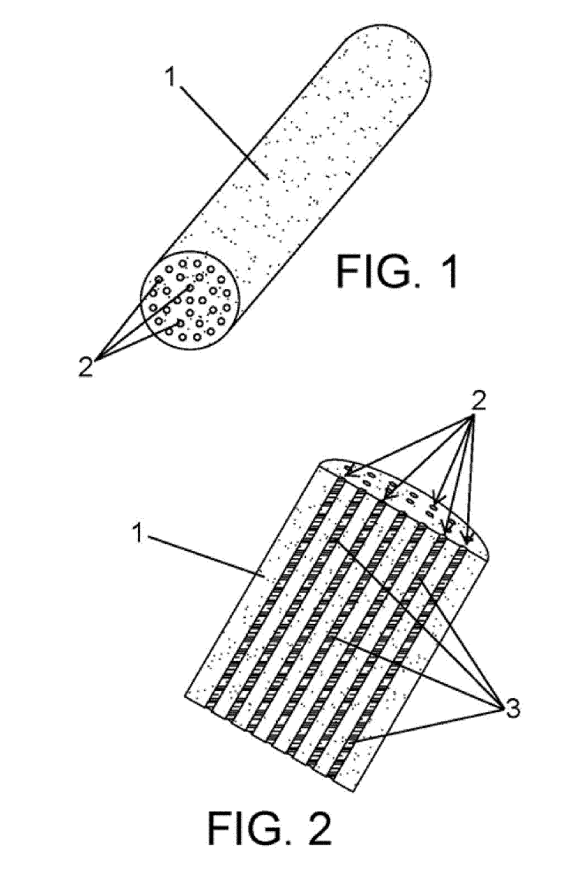

FIG. 1 shows the morphology of an example of filtration membrane according to the invention. The filtration membrane comprises a porous support (1) made of a single ceramic material, and inner channels (2) through which the liquid to be filtered is circulated.

FIG. 2 shows a cross-section of the filtration membrane in which the inner channels (2) are shown lengthwise. There are deposited on the inner walls of said channels (2) one or more porous layers (3) of ceramic material, acting as a semi-permeable physical barrier capable of separating the substances contained in the liquid to be filtered by means of applying pressure and according to the pore size thereof. So most of the liquid continues through the inner channels (2) of the membrane, and substances with sizes smaller than the pore size of the layers (3) of ceramic material are tangentially filtered through the porous layers (3) and the porous support (1) itself, where this filtered liquid is referred to as permeate.

The filtration membrane has a tubular geometry with external diameters between 8 and 80 mm and a length up to 2000 mm. The membrane has a single-channel structure, or a multi-channel structure of up to 85 channels, with internal channel diameters between 1 and 10 mm.

The porous support is made entirely of titanium oxide (TiO₂) with purity greater than 95%, where some traces of impurities may be present due to the raw material used.

The porous support is made using titanium oxide of at least two different grain sizes. The porous support therefore comprises a primary titanium oxide powder having a grain size between 10 and 50 microns and a secondary powder having a grain size at least 2 times smaller than the grain size of the primary powder, the grain size of the secondary powder being larger than 5 microns.

To make the porous support, a ceramic paste with titanium oxide powders of a different grain size, water, and other organic compounds such as plasticizers, binders, or lubricants, is prepared. After mixing and kneading the components, the ceramic paste is extruded to obtain a single-channel or multi-channel porous support, depending on the nozzle used in the extrusion. The “green” extruded porous support is subjected to thermal treatment with a sintering temperature comprised between 1200 and 1500° C.

The porous layers (3) of ceramic material deposited on the inner channels (2) of the porous support (1) have a pore size between 1 and 1000 nm. The ceramic material from which the porous layers (3) of ceramic material are made is selected from the group consisting of aluminum oxide (Al₂O₃), titanium oxide (TiO₂), zirconium oxide (ZrO₂), or silicon oxide (SiO₂).

According to the present invention, since the gradient of sizes of the different powder granules used is not too large, the pore size distribution is also narrow, which favors a homogenous adhesion of the layers deposited on the porous support. Furthermore, the use of primary powder with a grain size between 10 and 50 microns allows obtaining a support with pore sizes that are suitable for depositing layers that give rise to microfiltration, ultrafiltration, and nanofiltration membranes. Specifically, the mean pore size obtained in the support of the invention is comprised between 1 and 7 microns.

By adapting the sintering temperature to the grain size distribution used in each case, high porosities above 30% are also obtained, maintaining high mechanical strength greater than 40 MPa in three-point bending strength tests. The combination of mean pore size and high porosity allows obtaining a support with a high filtration capacity exceeding 5000 l/hm2 bar in tests with deionized water.

The use of a single material in the composition of porous supports also favors resistance to acidic and alkaline products used both in actual filtration processes and in chemical washes. Titanium oxide has a high resistance against etchings, and given the high purity of the porous supports (>95%) and the absence of other compounds having a different composition acting as weak points for these etchings, such as inorganic binders, for example, the mechanical strength of the supports is not compromised, where it remains above 35 MPa after etching with HNO₃ with a concentration of 4 wt % at 70° C. or with NaOH with a concentration of 1.5 wt % at 90° C.

According to a first embodiment of the invention, the porous support is made using a primary powder having a grain size of 30 microns in a percentage of 70-80% and a secondary powder having a grain size of 15 microns in a percentage of 20-30%.

Table 1 shows the properties of the porous support obtained according to the first embodiment of the invention. The percentages of the powders used are expressed in percentage by weight (weight of the component in relation to the total weight of the ceramic composition of the porous support). The same table also shows the porosity (mean pore size and percentage of porosity measured with the mercury intrusion porosimetry technique), the mechanical strength before and after etchings, and the deionized water permeability of the obtained supports.

TABLE 1

| | |
|---|---|
| TiO₂ with a mean granule size of 30 microns [%] | 70-80 |
| TiO₂ with a mean granule size of 15 microns [%] | 20-30 |
| Mean pore size [μm] | 4-6 |
| Porosity [%] | 30-40 |
| Three-point bending strength (MOR) [MPa] | ≥45 |
| MOR after HNO₃ (4 wt %) for 500 hours at 70° C. [MPa] | ≥35 |
| MOR after NaOH (1.5 wt %) for 500 hours at 90° C. [MPa] | ≥35 |
| Deionized water permeability [l/hm2bar] | >7000 |

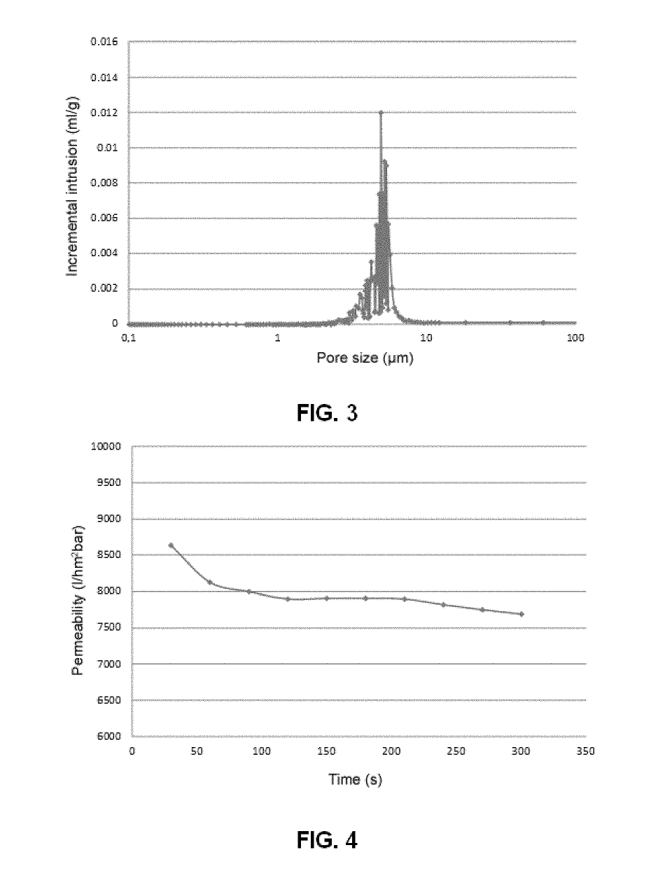

FIG. 3 shows the pore size distribution of a porous support developed following the composition of the first embodiment of the invention. In this case, the obtained mean pore size is comprised between 4-6 microns, showing a narrow distribution.

The permeability curve of the support developed following the composition of the first embodiment of the invention can be seen in FIG. 4, and it can be seen that after testing for 300 seconds, permeability remains above 7500 l/hm2 bar.

According to a second embodiment of the invention, the porous support is made using a primary powder having a grain size of 30 microns in a percentage of 85-90% and a secondary powder having a grain size of 15 microns in a percentage of 10-15%

Table 2 shows the properties of the porous support obtained according to the second embodiment of the invention. As can be seen, the properties of the porous support remain the same, where the percentage of porosity, mechanical strength, and permeability remain as high as in the porous support of the first embodiment of the invention; however, when the percentage of granules of the secondary powder having a smaller size decreases, the mean pore size of the support increases.

TABLE 2

| | |
|---|---|
| TiO₂ with a mean granule size of 30 microns [%] | 85-90 |
| TiO₂ with a mean granule size of 15 microns [%] | 10-15 |
| Mean pore size [μm] | 6.5-7 |
| Porosity [%] | 30-40 |
| Three-point bending strength (MOR) [MPa] | ≥45 |
| MOR after HNO₃ (4 wt %) for 500 hours at 70° C. [MPa] | ≥35 |
| MOR after NaOH (1.5 wt %) for 500 hours at 90° C. [MPa] | ≥35 |
| Clean water permeability [l/hm2bar] | >7000 |

1. A filtration membrane with high chemical resistance comprising a porous support with a primary titanium oxide powder and a secondary titanium oxide powder, wherein the primary powder has a grain size between 10 and 50 microns, and the secondary powder has a grain size at least 2 times smaller than the grain size of the primary powder, the grain size of the secondary powder being larger than 5 microns, and wherein the primary powder represents at least 50% by weight with respect to the total weight of the porous support, such that the porous support has a pore size between 1 and 7 microns and a percentage of porosity greater than 30%.

2. The filtration membrane with high chemical resistance according to claim 1, wherein the primary titanium oxide powder represents at least 70% by weight with respect to the total weight of the porous support.

3. The filtration membrane with high chemical resistance according to claim 1, wherein the titanium oxide support is sintered at a temperature comprised between 1300 and 1500° C.

4. The filtration membrane with high chemical resistance according to claim 1, additionally comprising one or more porous layers of ceramic material deposited on the porous support.

5. The filtration membrane with high chemical resistance according to claim 4, wherein the porous layers of ceramic material has a pore size between 1 and 1000 nm.

6. The filtration membrane with high chemical resistance according to claim 4, wherein the ceramic material of the porous layers is selected from the group consisting of Al₂O₃, TiO₂, ZrO₂, or SiO₂.
